(19) United States
(12) Patent Application Publication
(10) Pub. No.: US 2007/0259015 A1
(43) Pub. Date: Nov. 8, 2007

(54) Enhancer

(76) Inventors: Ricky Wayne Patterson, Crossett, AR (US); Robert Edward Throneberry, Sheridan, AR (US)

Correspondence Address: Robert Edward Throneberry, 10107 Hwy 167 So., Sheridan, AR, 72150, US

(21) Appl. No.: 11/416,602

(22) Filed: May 4, 2006

(51) Int. Cl. A01N 25/00

(52) U.S. Cl. 424/405

(57) ABSTRACT

The Enhancer is a mixture of 0.28 grams of Better Bait, which is a combination of sodium thiosulfate, acroflavine, metromersol sodium, and methylene blue, used to remove chlorine from water and 2.4 ounces of 46% nitrogen urea fertilizer, and Water, which, when added to Insecticides activates the ingredients of the insecticides resulting in a more effective method of killing fire ants and other insects.

The Enhancer, a mixture to be combined with insecticides for the purpose of killing fire ants. The Enhancer is not an insecticide and has no killing power when used by itself. The Enhancer is a synergist which activates the ingredients in most common insecticides, both liquid and soluble. The solution is formed by adding a mixture of granular sodium thiosulfate, acriflavine, metromersol, granular urea and water. The Enhancer when mixed with most common insecticides increases the killing effect of these insecticides, requiring less than recommended amounts of insecticides. Its main purpose is the elimination of fire ants. It is also effective in eliminating most garden insects and worms, as well as treating fruit trees to eliminate worms and insects.

1. A method of treating fire ants hills in the soil by penetrating the mounds with a liquid mixture formed by adding a mixture of granular sodium thiosulfate, acriflavine, metromersol, granular urea, and water. A liquid mixture with a viscosity low enough to flow through a pump sprayer for the purpose of spraying the enhanced composition on and around a fire ant hill for the purpose of killing fire ants.

2. The method of claim 1 wherein the source of the sodium thiosulfate, acriflavine, and metromersol is a combination of these ingredients in granular form

3. The method of claim 2 wherein the source of granular urea is in granular form.

4. The method of claim 3 wherein about 0.28 grams of the combination of granular sodium thiosulfate, acriflavine and metromersol is added per gallon of water

5 The method of claim 4 wherein about 2.4 ounces of granular urea is added per gallon of water.

### FIELD OF INVENTION

This invention relates to additives for insecticides and pesticides.

Fire ants are a serious threat to our population, animals, and plants with over 300 million acres infested in the United States and Puerto Rico, as well as in Australia, China, Hong Kong, and other countries causing billions of dollars of damage each year.

Countless treatments are available to combat the fire ant but none has stopped the progress of the fire ant in their movement and destruction. Most are bait treatments meant to be carried to the queen for the purpose of killing the queen and thus killing the mound.

Thus the object of this invention is to provide a mixture that can be combined with water and poisons to treat fire ant hills and kill fire ants in the process. This mixture will kill ants on contact. This mixture will not harm the soil or plants but will leave a residue in the soil that will promote plant growth and keep fire ants from returning to the area after killing out the first ant hill.

### SUMMARY OF THE INVENTION

The invention is a mixture of granular ingredients and water that can be mixed with common insecticides capable of being applied to the soil with a conventional pump sprayer

The granular form of sodium thiosulfate, acriflavine and metromersol sodium is available from a variety of companies. It is used to remove chlorine, and the reduction of bacterial and fungal problems from water used for live fish bait.

The granular urea is a fertilizer that is 46% Ammonium Nitrate available from several companies.

Testing

The mixture was used in a mix with numerous insecticides over a period of 14 years in a variety of areas such as lawns, gardens, pastures, and around structures. The mixture was found to be effective on fire ants, common garden insects, and on insects harmful to fruit. However the mixture with all insecticides was not effective on members of the wasp and bee family. It only agitated these two groups.

Tests were conducted in July 1993 by the University of Arkansas at Monticello with the following results.

Treated areas using different amounts of insecticide mixed with the Enhancer showed almost 80% reduction of mounds whereas areas treated with only insecticides only showed 50% reduction in mounds.

For each test a 0.1 acre plot was used

1 test plot using 2 oz. Per gallon of Dursban with Enhancer showed a 83% reduction in mounds.

1 test plot using 0.4 cc of Dursban with Enhancer showed a 78% reductions in mounds.

1 test plot using 0.4 cc & 0.8 oz. Dursban showed a 99% reduction in mounds.

The invented mixture is thus shown to be effective, when combined with insecticides, in the control and elimination of fire ants and other insects. This mixture when mixed with insecticides provides an effective means of controlling and killing fire ants with a reduced amount of insecticide.

Although this invention has been described in detail the spirit and scope should be limited to the description of the version contained herein.

1. This invention, The Enhancer, is a synergist, when combined with most common insecticides, activates the ingredients of the insecticides, creating a mixture which kills fire ants along with most bugs and insects, with the exception of bees and wasps.
To produce 1 (one) us gallon product:
0.28 grams of a mixture to contain the following:
Sodium Thiosulfate (Na₂S₂O₃-5H₂O)
Acroflavine (C₁₄H₁₄N₃CI)
Metromersol Sodium
Methylene Blue (C₁₆H₁₈CIN₃S)
2.4 ounces Urea (46%) (NH₄—CO—NH₂)
125.5 ounces dilution water (H₂O)
